(19) United States
(12) Patent Application Publication
(10) Pub. No.: US 2024/0278327 A1
(43) Pub. Date: Aug. 22, 2024

(54) ADDITIVE MANUFACTURING DEVICE

(71) Applicant: SAFRAN AIRCRAFT ENGINES, Paris (FR)

(72) Inventor: Hugo SISTACH, MOISSY-CRAMAYEL (FR)

(73) Assignee: SAFRAN AIRCRAFT ENGINES, Paris (FR)

(21) Appl. No.: 18/570,225

(22) PCT Filed: Jun. 14, 2022
(86) PCT No.: PCT/FR2022/051142

§ 371 Date: Dec. 14, 2023

(30) Foreign Application Priority Data
Jun. 15, 2021 (FR) FR2106334

(51) Int. Cl. B22F 12/60; B22F 12/00; B22F 12/30; B22F 12/55; B33Y 10/00; B33Y 30/00

(52) U.S. Cl. CPC B22F 12/60; B22F 12/222; B22F 12/224; B22F 12/30; B22F 12/55; B33Y 10/00; B33Y 30/00

(57) ABSTRACT

A device for additive manufacturing by powder bed fusion includes an enclosure having, in a lower portion of the enclosure, a manufacturing platform and a powder spreading means adapted to travel over the manufacturing platform in order to spread powder previously deposited on the manufacturing platform. The enclosure further includes, in an upper portion, a window facing the manufacturing platform and allowing the passage of laser beams. The device has at least one effector arranged in the enclosure and connected to at least two actuators, which are configured to move the effector between the upper portion of the enclosure and a target position on the manufacturing platform.

### DESCRIPTION

### Technical Field of the Invention

This document concerns an additive manufacturing device, in particular for manufacturing by powder bed fusion.

### Prior Art

Additive manufacturing devices allow manufacturing parts by selective powder fusion, using a laser additive manufacturing process known as Laser Beam Melting. Such a process consists of manufacturing a part by melting successive layers of powder by means of a laser beam controlled by an information processing system in which the three-dimensional coordinates of the points of the successive layers to be produced have been stored. In practice, a first layer of powder is deposited by a powder dispenser on the bottom of a chamber formed by a platform that is movable in vertical translation, using a scraper. The layer then has a lower surface corresponding to the upper surface of the platform and an upper surface on which the laser beam is directed and moved. The energy provided by the beam causes local fusion of the powder which, by solidifying, forms a first layer of the metal part.

After formation of this first layer, the platform is lowered by a distance corresponding to the thickness of a layer, then the scraper brings a second layer of powder onto the previous layer. In the same manner as before, a second layer of the metal part is formed by fusion using a laser beam or electron beam. These operations are repeated until the part is completely manufactured.

The powder dispenser is fixed in the enclosure and deposits a quantity of powder at the same location on the platform, generally in front of the scraper, at one of the edges of the manufacturing platform. The scraper pushes the deposited quantity of powder over all of the platform and thus spreads it over the entire surface of the manufacturing platform. It is not possible, with current devices, to deposit powder locally on a predetermined area of the manufacturing platform because these devices spread the powder over the entire platform at each powder deposition. In addition, these devices do not allow using several different materials in the same enclosure. Finally, the quantity of powder to be deposited in order to manufacture the parts is significant and requires numerous manipulation operations, since it is necessary to spread the powder over the entire platform, particularly if few parts are to be made.

There is a need for improvement in additive manufacturing devices.

### SUMMARY OF THE INVENTION

This document proposes a device for additive manufacturing by powder bed fusion, the device comprising an enclosure comprising, in a lower portion of the enclosure, a manufacturing platform and a powder spreading means adapted to travel over the manufacturing platform in order to spread thereon the powder previously deposited on the manufacturing platform, and comprising, in an upper portion of the enclosure, a window facing the manufacturing platform and allowing the passage of laser beams, the device comprising at least one effector arranged in the enclosure and connected to at least two actuators configured to move said effector between the upper portion of the enclosure and a target position on the manufacturing platform.

The device makes it possible to reach a target position on the platform and thus makes it possible to act locally at the target position.

At least one effector may be equipped with a powder dispenser. In particular, the powder dispenser may be removably mounted on said effector. This makes it possible to deposit powder locally at a powder deposition target position. This powder can be locally distributed at a target area by the spreading means.

At least one effector may be equipped with a powder suction device. For example, the powder suction device may be removably mounted on said effector. Cleaning of the enclosure is thus automated. The device also saves time when depowdering the enclosure because the powder suction device can be brought to a location on the manufacturing platform where there is powder.

The device may comprise a hose connecting the suction device to an air exhaust vent provided in one of the walls of the enclosure.

The powder dispenser or powder suction device may be snap-fitted or screwed into the effector. Such assembly may be automated or manual.

The enclosure may be parallelepipedal. The upper portion may comprise an upper wall of the enclosure which can be square or rectangular. The enclosure may be airtight when closed. The upper wall may be opaque to laser beams. The window may be provided in the upper wall and may comprise a pane adapted for the passage of laser beams.

The device may comprise a laser configured to emit laser beams perpendicular to the manufacturing platform.

The window may have smaller dimensions than the dimensions of the manufacturing platform, and the laser may be oriented to emit laser beams that reach the entire manufacturing platform.

The manufacturing platform may extend in a first direction and in a second direction which are perpendicular to each other.

The powder spreading means may be movable in the first direction.

Each effector may be operated by dedicated actuators. Alternatively, the actuators may be configured to drive at least two effectors in parallel.

For each effector, the device may comprise four actuators arranged in the upper portion of the enclosure and each connected by a cable to said effector.

The actuators may be linear motors configured to wind or unwind one of the cables.

The cables may extend in the first direction.

For each effector, an actuator may be arranged at a corner of the upper wall.

The upper portion may be arranged at a non-zero distance from the lower portion along the third direction. For example, the upper portion may be arranged at a distance of approximately 40 cm from the lower portion or approximately 1.5 times the width of the platform.

The lower portion may be formed by an area around the manufacturing platform along the third direction, for example up to 2 cm above the manufacturing platform, in other words towards the direction of the upper wall.

The manufacturing platform may be movable in a third direction perpendicular to the first direction and second direction. For example, the third direction may be vertical. In particular, the manufacturing platform may be lowered in the third direction to move away from the upper portion. For example, the manufacturing platform may be lowered by a height corresponding to one layer of the part being manufactured. Such a thickness may be between 20 and 60 microns, in particular equal to 40 microns.

For each effector, the actuators may be configured to move said effector in the first direction and/or the second direction.

For each effector, the actuators may be configured to move said effector in the third direction.

The device may comprise at least two effectors, each provided with a powder dispenser. The powder dispensers may comprise different powders. This makes it possible to deposit several materials on a certain layer of the part being manufactured or on certain areas of the manufacturing platform.

The device may comprise at least two effectors, each equipped with a powder suction device. For example, a specific powder suction device may be provided for each type of powder used in order to recover said powder, and a universal powder suction device may be provided to recover various waste powders in the enclosure. For example, each specific powder suction device can be arranged at the location where the specific powder is deposited, while the universal powder suction device can be arranged at transition locations between two locations where specific powders are deposited. This arrangement allows the powder to be recycled and saves material.

Alternatively, the powder dispensers may comprise the same type of powder.

The device may comprise several effectors each equipped with a powder dispenser, and/or several effectors each equipped with a powder suction device.

The device may comprise a first effector equipped with a powder dispenser and a second effector equipped with a powder suction device.

The powder spreading means may be a scraper or a roller. The scraper may be formed by a blade made of iron.

The device may comprise means for actuating the powder spreading means along the first direction so as to move the means upstream of the target position in the direction in which the manufacturing platform is traveling. For example, the powder spreading means can be brought to a distance of between 1 mm and 1 cm upstream of the target position.

The powder may be deposited gradually in front of the powder spreading means as it advances. The powder spreading means allows making the powder layer homogeneous in thickness.

The powder spreading means may have a dimension in the second direction that is greater than or equal to the dimension of the manufacturing platform in the second direction.

The enclosure may comprise, in the upper portion, one or more effector standby areas. For example, the standby area(s) may be an area of the upper wall not including the window.

The enclosure may comprise, in the upper portion, one or more tool changing areas, in which a powder dispenser and/or a powder suction device can be removed/mounted from/on the effector. For example, the tool changing area(s) may be areas of the upper wall not including the window, for example at an edge of the upper wall. The tool changing area may be combined with the standby area.

For example, a powder dispenser may comprise a powder stock hopper comprising powder and in communication with a cylinder provided with a rotary dispensing cross, the cylinder mouth leading to a powder dispensing opening. The cross allows measuring the deposition of the powder. The powder distribution opening can have dimensions between 2 and 10 mm, in particular around 4 mm, so that the powder does not remain blocked inside the cylinder. The quantity of powder deposited can be adjusted according to the speed at which the dispenser and the powder spreading means advance, and the rotation speed of the cross inside the dispenser. The quantity of powder to be deposited at the target position can be determined according to the volume of material in the layer to be manufactured.

In addition, the powder stock hopper may have a rectangular shape with asymmetrical side slopes forming an angle of less than 30° relative to the third direction or the vertical direction, to allow the powder to fall. The powder stock hopper can have a capacity of 2 L.

The enclosure may comprise a means of refilling the powder dispenser with powder. Such a means may be an opening connected to a powder storage tank. The opening may be arranged in the standby area or the tool changing area. The powder storage tank can have a capacity of 50 L.

When the effector is equipped with a powder dispenser, the actuators may be configured to bring the dispenser to a height between 1 mm and 10 mm from the manufacturing platform, in line with the target position, in order to deposit the powder onto the manufacturing platform.

The device may comprise means for calibrating the actuators in order to associate the frame of reference of the actuators with a reference position of the effector(s). Such calibration means may comprise an endstop sensor.

The powder may be a metal powder.

The device may be configured to manufacture a part of a turbomachine.

This document also concerns a use of a manufacturing device as mentioned above, comprising the steps of:

mounting a powder dispenser on an effector of the device,

moving the powder dispenser to the target position of the manufacturing platform,

depositing a predetermined quantity of powder, and

sweeping the manufacturing platform with the powder spreading means.

Multiple powder dispensers may be mounted in the enclosure, so that each effector is equipped with a powder dispenser.

Each powder dispenser may comprise a different powder and be at a predetermined target position.

Said use may further comprise the steps of:

exposing the manufacturing platform to a laser beam, and

lowering the manufacturing platform after exposure to the laser beam.

Said use may comprise the steps of:

replacing the powder dispenser with a suction device, and

suctioning, by means of the suction device, around a target position on the manufacturing platform.

In particular, the steps of replacing and suctioning can be carried out before lowering the manufacturing platform.

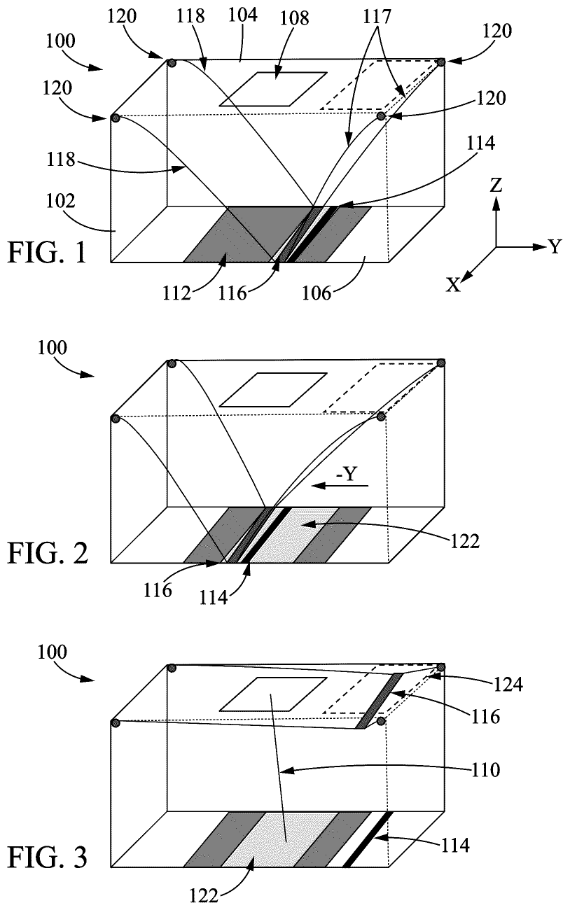

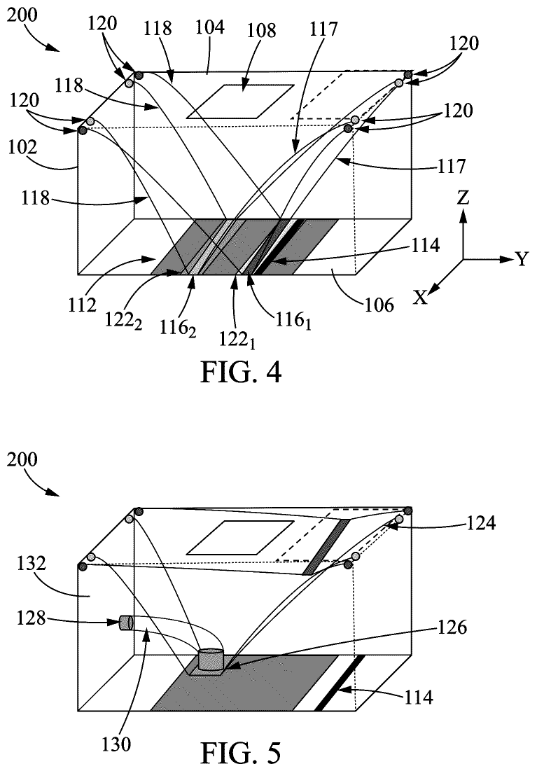

### BRIEF DESCRIPTION OF THE FIGURES

[FIG. 1] is a schematic representation of a first exemplary embodiment of an additive manufacturing device in a first operating configuration.

[FIG. 2] is a schematic representation of the device of FIG. 1 in a second operating configuration.

[FIG. 3] is a schematic representation of the device of FIG. 1 in a third operating configuration.

[FIG. 4] is a schematic representation of a second exemplary embodiment of an additive manufacturing device in a first operating configuration.

[FIG. 5] is a schematic representation of the device of FIG. 4 in a second operating configuration.

### DETAILED DESCRIPTION OF THE INVENTION

With reference to FIGS. 1 to 3, additive manufacturing device 100 comprises a parallelepiped enclosure 102 comprising an upper wall 104 and a lower wall 106. Upper wall 104 comprises a window 108 provided with a pane enabling the passage of laser beams 110 while the rest of the upper wall is opaque to laser beams. A manufacturing platform 112 is connected to lower wall 106 and lies in plane XY. Manufacturing platform 112 can move along axis Z, in particular in the −Z direction.

Device 100 comprises a scraper 114 formed by a blade made of iron and adapted to be movable along axis Y. Scraper 114 is arranged above manufacturing platform 112 and can sweep the surface of manufacturing platform 112 along the −Y direction. The width of scraper 114 along axis X is equal to the width of manufacturing platform 112 along axis X. In one embodiment, scraper 114 can be replaced by a roller adapted to sweep the surface of manufacturing platform 112.

Device 100 further comprises an effector equipped with a powder dispenser 116 connected to motors 120 by four cables 117 and 118 extending along axis Y. Cables 117 are arranged upstream of the dispenser in the −Y direction of movement of scraper 114, and cables 118 are arranged downstream of dispenser 116 in the −Y direction of movement of scraper 114.

Each motor 120 is arranged at a corner of upper wall 104. The winding of cables 118 and the unwinding of cables 117 moves scraper 116 in the −Y direction, and vice versa.

Cables 117 and 118 may be metal or nylon cables which allow holding the weight of the dispenser.

During operation, scraper 114 is brought upstream of a powder deposition target position in the −Y direction. For example, the scraper is arranged at a distance of approximately 5 mm upstream of the powder deposition target position.

Dispenser 116 is then moved by motors 120 to the powder deposition target position.

Dispenser 116 can be arranged at a distance of 1 mm from the manufacturing platform in the Z direction relative to the projection in plane XY of the deposition target position.

Dispenser 116 comprises a powder stock hopper filled with powder and in communication with a cylinder in which a rotary dispensing cross is arranged. The cylinder mouth leads to a powder dispensing opening, which can have a width or diameter of between 2 and 10 mm, in particular around 4 mm. The powder stock hopper can have a capacity of 2 L.

Dispenser 116 is actuated to deposit powder as it moves in the −Y direction in front of scraper 114. The latter may move simultaneously with the movement of dispenser 116 and allows spreading the powder, forming a powder bed 122 in a layer of homogeneous thickness.

The quantity of powder deposited by dispenser 116 is regulated according to the speed at which dispenser 116 and scraper 114 advance, and the rotation speed of the cross inside the cylinder of dispenser 116.

As shown in FIG. 3, once the powder bed has been formed, dispenser 116 is moved to a standby area 124 at upper wall 102, set back from window 108 so as not to obstruct the passage of laser beams 110. Scraper 114 is also moved to an initial position, for example to an edge of manufacturing platform 112. The initial position of scraper 114 may be external to manufacturing platform 112, on lower wall 106 of enclosure 102.

Powder bed 122 is then exposed to laser beams 110 for a predetermined duration, which causes it to melt and form a layer of material after it solidifies.

At the end of this operation, manufacturing platform 112 is lowered in the −Z direction by a distance equivalent to the thickness of the layer formed, for example approximately 40 microns. Powder can again be deposited on manufacturing platform 112 to form the next layer on top of the already formed layer.

Dispenser 116 can be disassembled from its support connecting it to cables 117 and 118. A suction device (not shown in FIGS. 1 to 3) can be mounted on the support in place of dispenser 116. The suction device can sweep the layer formed in order to depowder the enclosure before a new layer of powder is applied. The suction device may be connected via a flexible hose to a waste bag outside the enclosure.

Disassembly of dispenser 116 may take place at standby area 116. This change may be automated or manual.

Enclosure 102 may comprise a powder infeed opening, for example arranged at standby area 116. This powder infeed opening may be connected to a powder storage tank of greater capacity than the powder stock hopper of dispenser 116, for example having a capacity of 50 L, and allows the powder stock hopper of dispenser 116 to be refilled when it is empty or at an insufficient level.

Device 100 may comprise means for actuating dispenser 116 along axis X. Such means may comprise motors, mounted on the support which attaches dispenser 116, and connected to dispenser 116 by cables extending along axis X.

With reference to FIGS. 4 and 5, additive manufacturing device 200 comprises the same elements as device 100. In addition, device 200 comprises a first dispenser 116₁ and a second dispenser 116₂. Each of dispensers 116 is connected by cables 118 and 117 to motors 120. Each dispenser 116 moves independently of the other dispenser 116. The hopper of first dispenser 116₁ comprises a first powder and the hopper of second dispenser 116₂ comprises a second powder that is different from the first powder.

As shown in FIG. 4, first dispenser 116₁ is brought to a first powder deposition target position and second dispenser 116₂ is brought to a second powder deposition target position. Once the first and second powders have been deposited, scraper 114 is actuated to sweep the entire surface of manufacturing platform 112 and thus forms a first bed of powder 122₁ and a second bed of powder 122₂. A means for cleaning scraper 114 may be provided between the first and second powder deposition positions, to avoid mixing the first powder and second powder. The exposure of manufacturing platform 112 makes it possible to form two layers of different materials. The first powder and second powder may be metal powders.

Standby area 124 may accommodate first dispenser 116₁ and second dispenser 116₂ simultaneously. Alternatively, standby area 124 may accommodate only one among first dispenser 116₁ and second dispenser 116₂, it being possible for the enclosure to comprise another standby area, arranged for example opposite standby area 124 relative to window 108, to accommodate the other among first dispenser 116₁ and second dispenser 116.

As shown in FIG. 5, second dispenser 116₂ may be replaced by a suction device 126 connected by a hose 130 to an opening 128 provided in a side wall 132 of the enclosure. Opening 128 may be connected to a powder collection bag. Suction device 126 may sweep the entire enclosure 102 in order to remove powder, or only an area around the second powder deposition target position. Suction device 126 can thus be used to recover any waste in the enclosure, or only the remaining second powder after laser beam exposure. During cleaning of the enclosure, scraper 114 is arranged in the initial position.

Similarly, first dispenser 116₁ can be replaced by a suction device which can be used to recover only the remaining first powder.

1.-8. (canceled)

9. A device for additive manufacturing by powder bed fusion, the device comprising:
an enclosure comprising:
in a lower portion of the enclosure, a manufacturing platform and a powder spreading means adapted to travel over the manufacturing platform in order to spread thereon the powder previously deposited on the manufacturing platform; and
in an upper portion of the enclosure, a window facing the manufacturing platform and allowing the passage of laser beams; and
at least two effectors arranged in the enclosure and connected each to at least two respective actuators, the at least two respective actuators being configured to move said at least two effectors between the upper portion of the enclosure and a target position on the manufacturing platform, each of the at least two effectors being provided with a powder dispenser, the powder dispensers of the at least two effectors being movable independently from one another along at least two directions of space, and the powder dispensers of the at least two effectors comprising different powders.

10. The device according to claim 9, wherein at least one of the at least two effectors is equipped with a powder suction device.

11. The device according to claim 9, further comprising, for each effector of the at least two effectors, four actuators arranged in the upper portion of the enclosure and each connected by a cable to a respective effector of the at least two effectors.

12. The device according to claim 9, wherein the manufacturing platform extends in a first direction and in a second direction which are perpendicular to each other, and the manufacturing platform is movable in a third direction which is perpendicular to the first direction and second direction.

13. The device according to claim 12, wherein each effector of the at least two effectors is movable in at least one of: the first direction and the second direction.

14. The device according to claim 9, wherein the powder spreading means is a scraper or a roller.

15. A method of using of a device for additive manufacturing by powder bed fusion, the device comprising:
an enclosure comprising:
in a lower portion of the enclosure, a manufacturing platform and a powder spreading means adapted to travel over the manufacturing platform in order to spread thereon the powder previously deposited on the manufacturing platform; and
in an upper portion of the enclosure, a window facing the manufacturing platform and allowing the passage of laser beams; and
at least two effectors arranged in the enclosure and connected each to at least two respective actuators, the at least two respective actuators being configured to move said at least two effectors between the upper portion of the enclosure and a target position on the manufacturing platform, each of the at least two effectors being provided with a powder dispenser, the powder dispensers of the at least two effectors being movable independently from one another along at least two directions of space, and the powder dispensers of the at least two effectors comprising different powders,
the use comprising:
mounting a powder dispenser on an effector of the device;
moving the powder dispenser to the target position of the manufacturing platform;
depositing a predetermined quantity of powder, and
sweeping the manufacturing platform with the powder spreading means.

16. The method according to claim 15, further comprising the steps of:
replacing the powder dispenser with a suction device; and
suctioning, by means of the suction device, around a target position on the manufacturing platform.
